(19) United States
(12) Patent Application Publication
(10) Pub. No.: US 2011/0234898 A1
(43) Pub. Date: Sep. 29, 2011

(54) DEVICE AND METHOD FOR SCANNING IMAGES BY LASER PROJECTOR

(76) Inventor: Nir Goren, Moshav Herut (IL)

(21) Appl. No.: 13/133,128

(22) PCT Filed: Dec. 3, 2009
(86) PCT No.: PCT/IL2009/001145

§ 371 Date: Jun. 6, 2011

(30) Foreign Application Priority Data
Dec. 14, 2008 (IL) 195919

(51) Int. Cl. H04N 5/74; H04N 7/01

(52) U.S. Cl. 348/446; 348/744; 348/E07.003; 348/E05.137

(57) ABSTRACT

A laser projector comprising at least one source for laser beams, a mirror mechanism adapted to reflect laser beams is disclosed, for providing a plurality of projected frames wherein each of the plurality of projected frames is generated by laser beams scanning an image both in the horizontal direction and in the vertical direction, wherein at least two frames from among the plurality of projected frames are generated by using laser beams each of which having at least one different projecting parameter than the other frame, and wherein the projecting parameter is a member selected from a group consisting of: a frame's starting point for the beam's scanning, a frame's starting scanning time, picture information and horizontal and/or vertical cycle times.

### FIELD OF THE INVENTION

The present invention relates generally to image scanning and more particularly to scanning methods for use by laser scanning projectors.

### BACKGROUND OF THE INVENTION

The image quality is a crucial factor when examining any multi-media devices. Some of parameters defining image quality are the image sharpness (which determines the amount of details that a single image may convey), the noise (which is a random variation of image density, visible as grains in the image and pixel level variations in digital images), the contrast (which is the slope of the tonal response curve), the distortion (i.e. an aberration that causes straight lines to curve near the edges of images) and others. As a rule of thumb, one may say that the bigger the image is, the more difficult it would be to display it at a high quality, according to the parameters defined above. This is a challenge that all projectors manufactures have to deal with, but with MEMS (MicroElectroMechanical Systems) based laser scanning projectors the challenge is substantially increased, even though MEMS projectors that are based on laser projection optics enable a ‘focus free’ solution, thereby saving the focus lens mechanism as well as the need for polarizer and diffuser. The MEMS laser projectors have a very complicated, fragile scanning mirror architecture that is based on a modulated laser source and reflective mirrors mechanism, and yet there are several problems associated with MEMS laser projectors that lead to lowering the image quality.

Several attempts were made in the past to improve the image quality of images projected by using MEMS laser scanning projectors. Following are examples of such attempts.

US 20080225366 discloses a prism capable of being utilized in a scanned beam projector where the prism comprising two surfaces disposed at a non-parallel angle with respect to each other to reduce distortion of the scan pattern or image

US 2008031102 discloses a system and method for synchronizing the low speed mirror movement of a mirror display system with incoming frame or video signals, and to synchronize buffered lines of video data to the independently oscillating scanning mirror. According to this publication, the peak portions of the low speed cyclic drive signal are synchronized with the incoming frames of video by compressing or expanding the peak portion or turn around portion so that each video frame begins at the same location on the display screen. The actual position of the high frequency mirror is determined by sensors and a trigger signal is generated to distribute the signals for each scan line such that the scan lines are properly positioned on the display.

Nowadays there are two main approaches for the mirror mechanisms applied in laser scanning projector, a Bi-Axial mirror (i.e. a single mirror tilting in orthogonal axes using a mechanism of two perpendicular gimbals) and a set of two Uni-Axial mirrors (i.e. a pair of mirrors, each tilting around one axis and configured to generate the movement in two orthogonal dimensions). By the second approach the laser scanning projectors usually employs two types of mirrors: resonant mirrors, which actuate close to their natural frequency thereby resulting in a sinusoidal scan, and linear mirrors, which in a static case tilt in proportion to the input signal. The mirrors mechanism reflects three visible, optically-combined red, green and blue (RGB) laser beams, and the color information is generated by synchronous modulation of the laser RGB color sources. In systems where the horizontal mirror is a fast resonant mirror and the vertical mirror is a slow linear mirror, the image is drawn during the scanning period of the vertical mirror on both scan directions of the linear mirror. Ideally, in order to create the image, the vertical mirror would perform a step function so it would “jump” to the next line at the end of each scan line. Due to mirror mass, implementation of a step function is virtually impossible, therefore the vertical mirror is driven in a continuous slope. Drawing an image on both scan directions of the horizontal mirror and using a continuous slop of the vertical mirror results in tilted scan lines as illustrated in FIG. 1. These tilted scan lines are in fact the path of the laser beam (110) and the reason for the image not to be displayed properly, is, that as may be noted, that some parts of the image are never reached while others are being scanned twice. The common scanning method described above results in a discontinuous image (i.e. some parts of the lines are not scanned, a problem which becomes more significant as we get closer to the edge of the projected image). This effect is demonstrated in FIG. 2A and in an enlarged portion thereof, presented in FIG. 2B. Another restriction due to physical limitation is that the mirror is of Biaxial type or, the two mirrors' rotational axis are not orthogonal to each other and the effect described above (and demonstrated in FIG. 2A and FIG. 2B) further exceeds, and consequently the image quality drops. Therefore, in order to get good image quality while using laser scanning projectors, there is a need to overcome the above mentioned problems.

### SUMMARY OF THE INVENTION

It is an object of the present invention to provide a laser scanning projector and novel scanning methods to obtain improved quality of projected images.

It is also an object of the present invention to provide a laser scanning projector and scanning methods to diminish the distortion that occurs at the image edges.

It is another object of the present invention to provide a laser scanning projector and scanning methods that use a pixel-based manipulation in order to fix faults arising due to the use of biaxial mirror or due to mirrors' rotational axis that are not orthogonal to each other.

It is yet another object of the present invention to provide a laser scanning projector and scanning methods for making real time manipulation of the scanning pattern in order to improve its quality.

Other objects of the present invention will become apparent as the description of the invention proceeds.

According to a first embodiment of the present invention there is provided a laser projector comprising at least one source for emitting laser beams, a mirror mechanism adapted to reflect the laser beams emitted from the at least one source for laser beams, to provide a plurality of projected frames, wherein each of the plurality of frames is generated by laser beams scanning an image both in the horizontal direction and in the vertical direction, wherein at least two frames from among that plurality of projected frames are generated by using laser beams each having at least one different projecting parameters than the other, and wherein a projecting parameter is a member selected from a group consisting of: a starting scanning point, starting scanning time, picture information and horizontal and/or vertical cycle times, and the like.

The beams are projected by the laser projector of the present invention in a way that any beam scanning an image in the horizontal direction is adapted to travel from one side to another while continuously scanning the image. As will be appreciated by those skilled in the art, during each such horizontal cycle (i.e. during which the beam in the horizontal direction travels back and forth) the vertical mirror moves linearly in the vertical direction.

According to another embodiment of the invention the projector further comprises means to enable interlacing the at least two frames, generated by using laser beams each having at least one different projecting parameters than the other.

According to another embodiment of the present invention there is provided a laser scanning projector, wherein a projected image is being formed so as to enable a human eye to average the plurality of projected frames over a scanning session. The term “scanning session” as used herein should be understood to encompass a period that extends for any length of time from the duration of a cycle time of the slow scanning vertical mirror up to the length of time during which the projector operates.

As mentioned hereinbefore, there are two main approaches for mirror mechanisms applied in laser scanning projector, a Bi-Axial mirror and a set of two Uni-Axial mirrors. According to another embodiment of the invention, the laser scanning projector comprises a plurality of resonant mirrors and a plurality of linear mirrors.

According to a preferred embodiment of the present invention, the laser scanning projector further comprises a processing means operative to provide correcting pixel information (e.g. to soften the quantized pixel information) adjusted so as to take into consideration the path to be travelled by the laser beam in accordance with one or more of the following:

path curvature caused by the use of a biaxial mirror;

path curvature caused due to the positioning of at least one of the mirrors comprised in the mirror mechanism preventing the mirrors' rotational axis from being orthogonal to each other;

path curvature caused by a multiplicity of mirrors; and

deviation from theoretical path, caused by the current position of at least one of the mirrors comprised in the mirror mechanism.

The term “correcting pixel information” as used herein throughout the specification and claims is used to denote either information that may be apply in order to correct the pixel, or already the pixel information that had already been corrected,

The laser beam path may be for example a convex or concave path.

According to another embodiment of the present invention the laser scanning projector further comprising a processing means adapted to calculate the current position of the mirrors comprised in the mirror mechanism and to provide correcting pixel information in accordance with the current position of the mirrors. In MEMS devices the accuracy is of extreme importance and even the slightest divergence from the designed position might have an adverse impact upon the outcome of the image quality. By applying a real-time monitoring of the mirrors' position, the solution provided by the present invention yields a more reliable laser scanning projector.

According to yet another embodiment of the invention, the laser scanning projector further comprising processing means adapted to calculate off-line or under real-time conditions, the number of frames required to be interlaced for optimizing the image quality of the projected image and diminishing the distortion, based on the mirror(s) curvature and/or the mirrors' current position. The decision of how many frames required may preferably also depend on the refreshing rate and/or viewer preference.

In accordance with yet another embodiment of the present invention, the processing means is further adapted to execute a real-time pixel-based manipulation to enable improve the projected image quality based upon the mirrors' curvature and/or the mirrors' current position. In other words, based upon the calculated expected location of each pixel and the calculated actual deviation there from, the location of one or more pixels in the image to be displayed is changed.

By yet another aspect of the invention a method is provided for projecting an image comprised of a plurality of projected frames by using a laser projector which comprises at least one biaxial mirror or at least one resonant mirror and at least one linear mirror, the method comprises generating at least two laser beams each adapted to be associated with a different frame from among the plurality of projected frames, wherein each of the at least two laser beams has at least one different projecting parameter than the other, and wherein a projecting parameter is a member selected from a group consisting of: a starting scanning point, starting scanning time, picture information and horizontal and/or vertical cycle times, and the like.

Preferably, the plurality of projected frames is generated by laser beams scanning corresponding images in both resonance directions.

According to another embodiment the method provided further comprises a step of calculating the pixel position according to the paths to be travelled by said at least two laser beams, based upon one or more of the following:

path anfractuosity caused by the use of a biaxial mirror;

path anfractuosity caused due to the positioning of at least one of the mirrors comprised in the mirror mechanism preventing the mirrors' rotational axis from being orthogonal to each other;

path anfractuosity caused by a multiplicity of mirrors; and

deviation from theoretical path caused by the current position of at least one of the mirrors comprised in the mirror mechanism.

By yet another preferred embodiment the method provided further comprises a step of interlacing the at least two frames and projecting the interlaced frame onto a target.

Preferably, the method further comprises a step of determining a number of frames required to be interlaced for optimizing the image quality of a projected image.

By still another preferred embodiment, the method further comprises a step of affecting the image quality by executing a pixel-based manipulation of the interlaced frames to be projected.

### BRIEF DESCRIPTION OF THE FIGURES

For a more complete understanding of the present invention, reference is made to the following detailed description taken in conjunction with the accompanying drawings wherein:

FIG. 1 demonstrates schematically the laser beams path in a scanning process carried out according to prior art devices;

FIG. 2A presents a projected image derived by using a scanning process as known in the prior art;

FIG. 2B presents an enlargement of one part of the projected image shown in FIG. 2A;

FIG. 3 presents a schematic example of a laser scanning projector according to an embodiment of the present invention;

FIG. 4 illustrates schematically the laser beams' path in a scanning process carried out according to an embodiment of the present invention;

FIG. 5 illustrates a two phase scanning process according to the present invention;

FIG. 6 illustrates a four phase scanning process according to the present invention;

FIG. 7A presents a projected image derived by using a scanning process according to an embodiment of the present invention;

FIG. 7B presents an enlargement of part of the projected image shown in FIG. 7A; and

FIGS. 8A and 8B—present another example of a projected image derived without using a scanning process according to present invention (FIG. 8A) and the improvement achieved by using the scanning process according to present invention (FIG. 8B)

### DETAILED DESCRIPTION OF THE INVENTION

Let us look at the schematic example of a laser scanning projector demonstrated in FIG. 3. The laser scanning projector (300) comprises a modulated laser source (301) which in turn comprises three laser diodes (Red, Green and Blue), each of which is accompanied by a circularization lens and collimation lens (not shown in this Fig.). Each laser diode is initially circularized and then collimated according to the required beam parameters. The resulting shaped laser beams are then projected toward an RGB combiner (305) that combines the three modulated light sources into a single RGB beam. The unified beam is then directed towards mirror mechanism (310), which comprises two mirrors. One horizontal mirror (312) which is a fast scanning (e.g. 16-22 KHz) resonant mirror and one vertical mirror (314) which is a slow scanning (e.g. 55-80 Hz) linear mirror. The image is drawn during the scan cycle time of the vertical mirror on both scan directions of the resonance mirror and projected on a two-dimension screen (320).

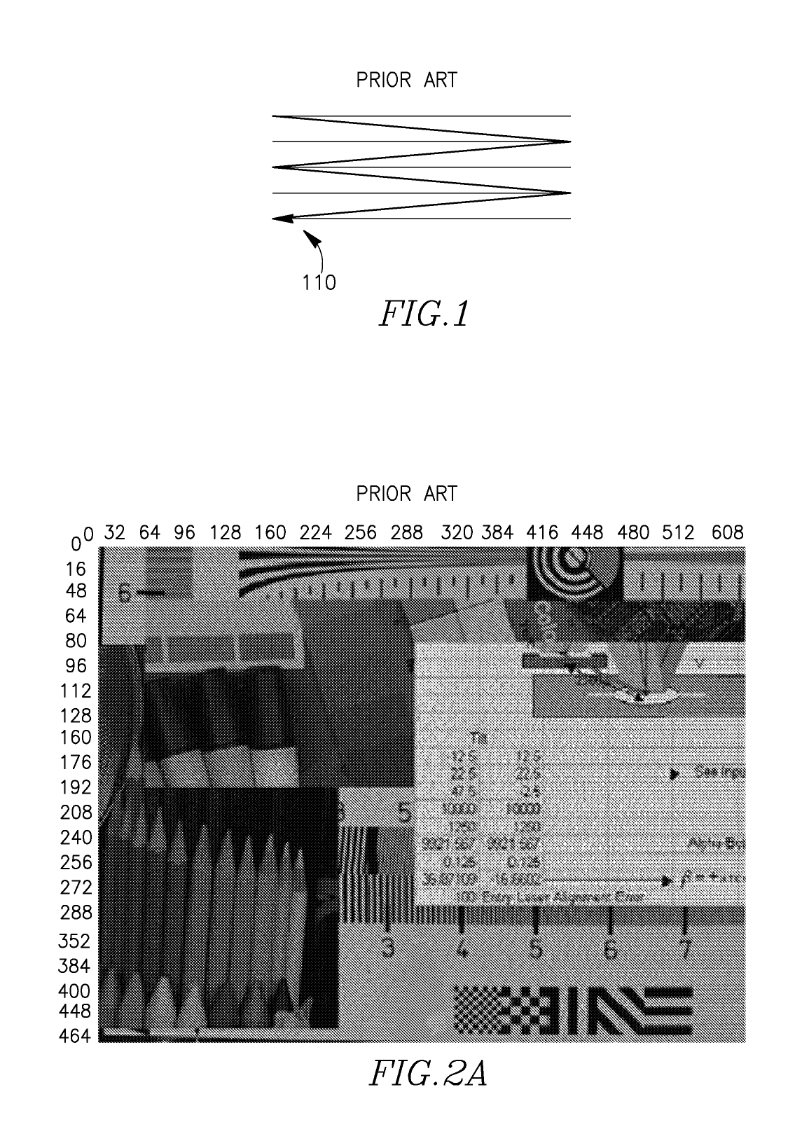

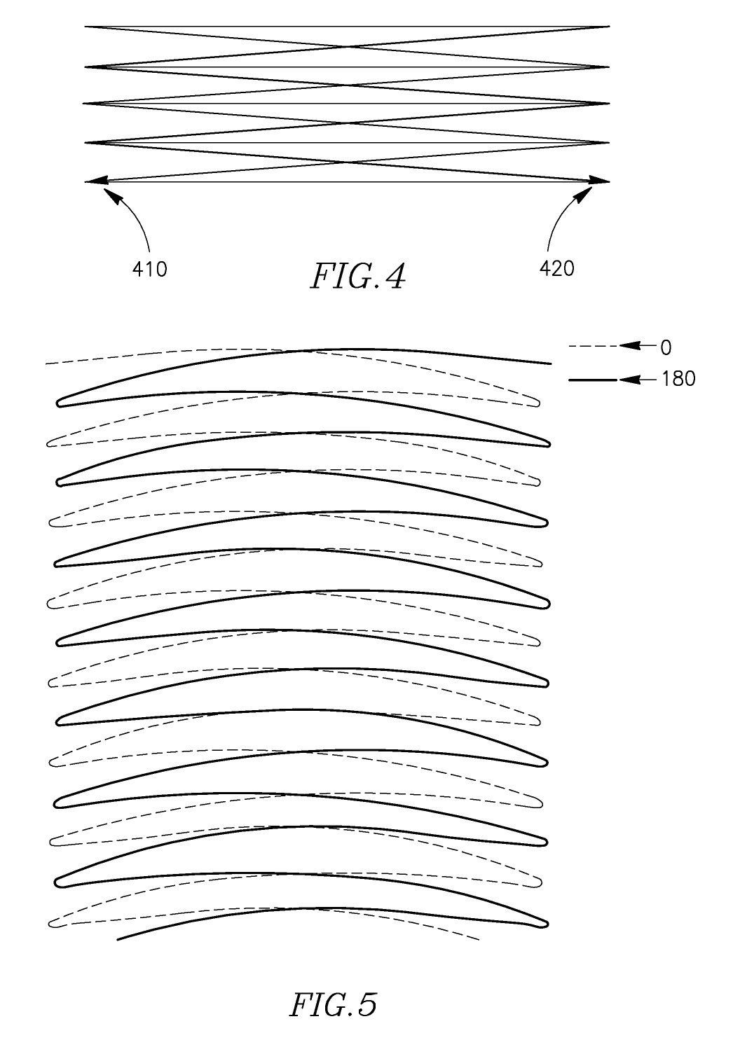

FIG. 4 illustrates a path which the laser beams travel in a scanning process according to the present invention, in an example where the two mirrors (the vertical and the horizontal) are perfectly orthogonal to each other. Unlike the image obtained through the scanning process described in FIG. 1, in the case illustrated in FIG. 4, there are two laser beams (410 and 420), each of which drawing an image on both scan directions of the horizontal mirror and using a continuous slop of the vertical mirror movement, resulting in the generated frame. Thus, one may consider a frame to be the outcome of a horizontal scanning laser beam during a period which is equal to the cycle time of the slow scanning vertical mirror.

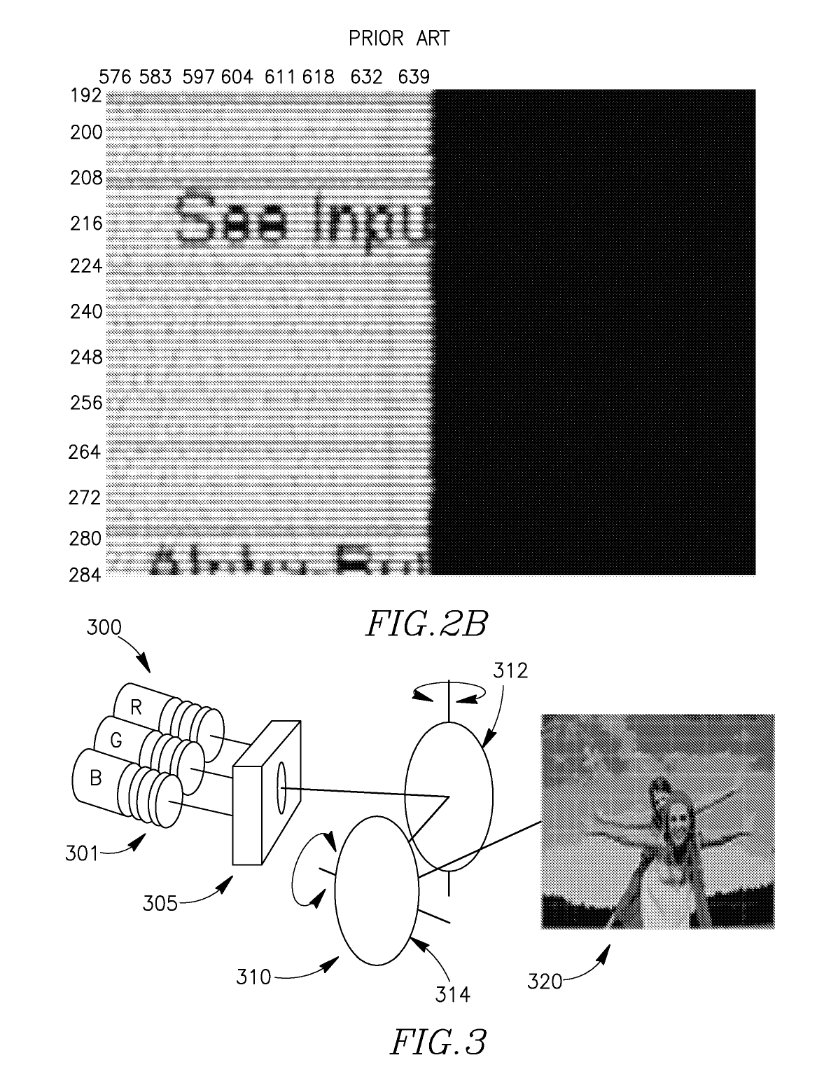

In the example illustrated in FIG. 4 two frames are generated by the two laser beams. Each frame starts at a different scanning position, the frame generated by laser beam 410 is drawn from the right, while the frame generated from laser beam 420 is drawn from the left. The two frames are interlaced and the result is an image having a high image quality. Whereupon the projected image in the prior art had a missing part at the end of the lines (as demonstrated in FIG. 2A and FIG. 2B), the projected image drawn by a laser scanning projector according to the present invention is a complete image as may be seen from FIG. 7A and FIG. 7B.

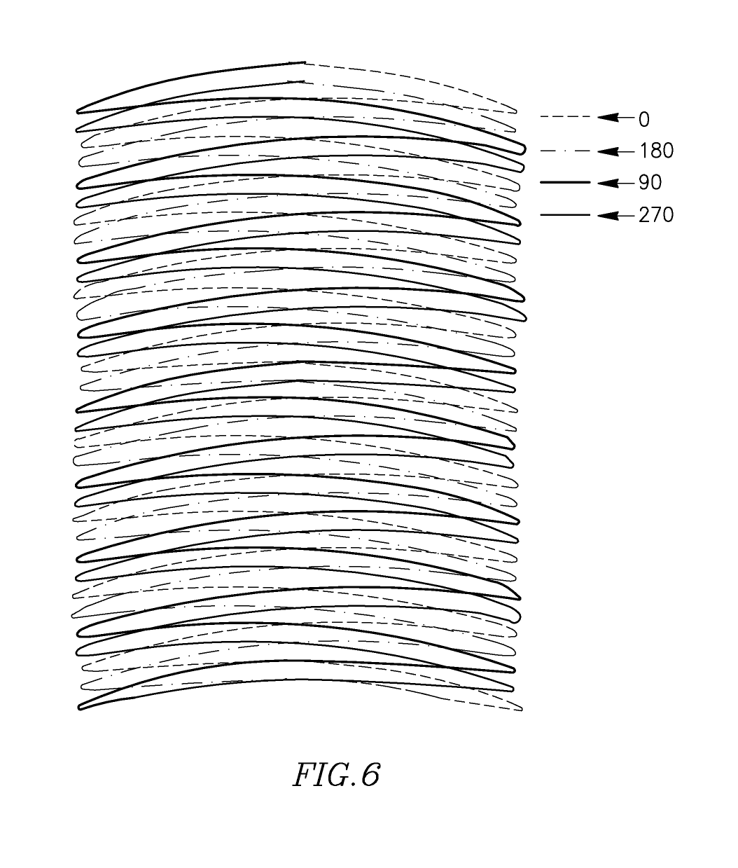

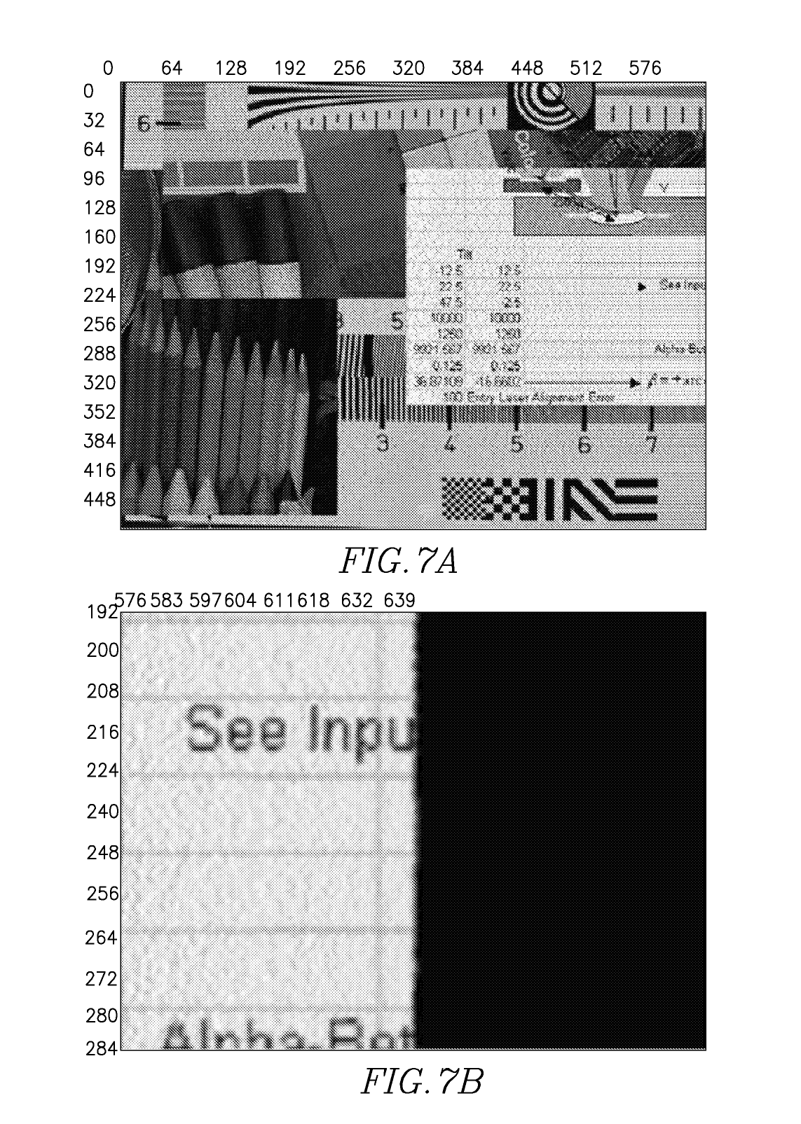

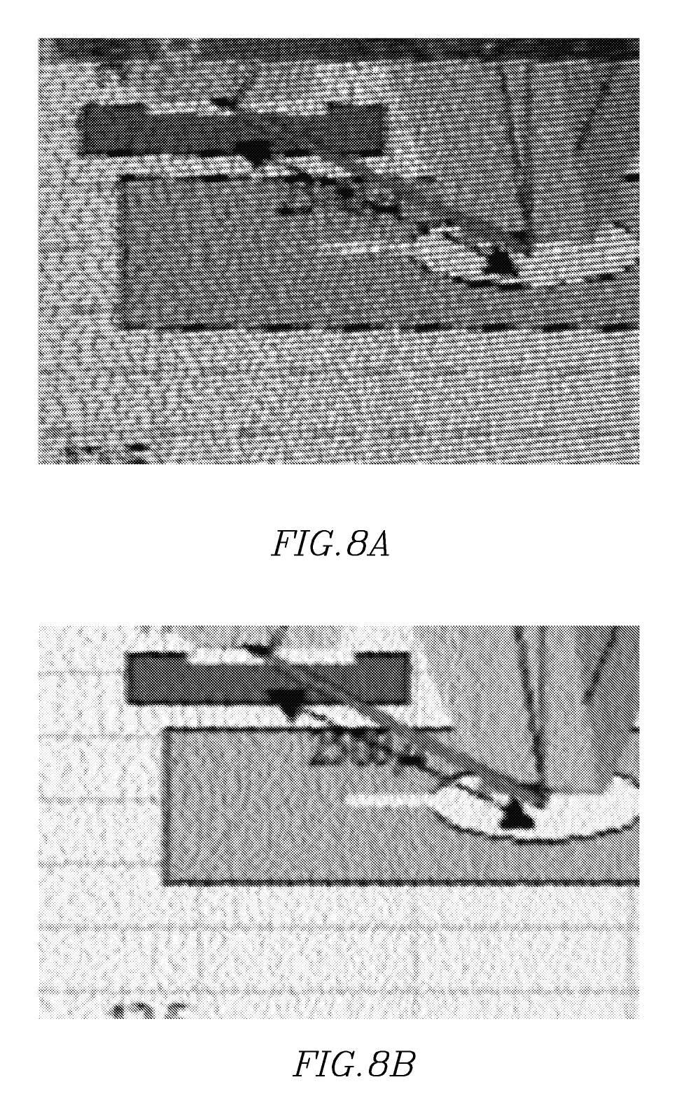

Similarly, FIG. 5 and FIG. 6 illustrate the paths take in a two phase and four phase scanning processes, respectively.

In the example described above, only two laser beams were participating in the scanning process and accordingly only two frames were interlaced. However, the present invention should not be considered to be limited to any particular number of laser beams participating in the scanning process or to specific locations where the scanning of each beam begins. In case where the two mirrors' rotating axis (the vertical and the horizontal ones) are perfectly orthogonal there is no need to use more than two laser beams in order to get a satisfying result. Unfortunately, having two rotational axis of mirrors being orthogonal to each other is not the typical case. Due to mainly packaging limitations, in most cases one would find that the mirrors' rotational axis are not orthogonal to each other and interlacing two frames might not be sufficient. As will be appreciated by those skilled in the art, there could be other reasons for the mirrors' rotational axis to deviate from the ideal position of being orthogonal to each other.

By an embodiment of the invention, the laser scanning projector comprises a processor means adapted to calculate the current position and spatial configuration of the horizontal and the vertical mirrors. The effect described hereinbefore, wherein the scanning laser beam does not reach every point in the to be scanned path and especially those at the end of the horizontal lines, which might lead to ending up with holes in the projected image, is further intensified when the two mirrors' rotational axis are not orthogonal to each other. In order to overcome this effect, the laser scanning projector of the present invention is adapted to use apart from using different projection parameters such as starting the scanning at different points of the frames, data available on the mirrors' position and their spatial configuration to determine the number of frames needed to interlace with each other for optimizing the image quality of the projected image. Based on the number of needed frames, on the refreshing rate and on the scan path curvature, the laser scanning projector initiates a number of laser beams where, as mentioned before, each laser beam would have at least one different starting parameter than the others. The starting parameters of each laser beam may be the scanning starting point e.g. represented as a phase.

As previously explained, according to an embodiment of the invention the method provided further comprises a step of determining a number of frames required to be interlaced for optimizing the image quality of a projected image. An example of such an algorithm to determine the number of frames required to be interlaced is n=[F/25], were n is the required number of different frames, F is the frame refresh rate in frames/second and [ ] denotes the integer that is equal to or higher than the result of the division operation. 25 frames/second are the assumed minimum rate that the human eye could integrate the frames.

In the example demonstrated in FIG. 4, one of the beams starts the scanning at the right side of the frame whereas the other beam at the left side, in other words, beam 410 starts with phase 0° and beam 420 starts with phase 180°.

Data that relates to the position of the horizontal and the vertical mirrors, and data that relates to their designed curvature can also be used to derive the exact path of the laser beam and then any further distortion (e.g. edge distortion) of the image to be projected may be rectified by executing a real-time pixel-based manipulation (i.e. by knowing which pixel should be where, and replacing or moving certain pixels at the image when projected by the laser scanning projector).

Another example of results obtained by using the device of the present invention is demonstrated in FIGS. 8A and 8B, where the image presented in FIG. 8A was obtained without applying the method provided by the present invention, whereas FIG. 8B is the image obtained while using this method.

The present invention has been described using non-limiting descriptions of preferred embodiments that are provided by way of example and are not intended to limit the scope of the invention. It should be understood that features described with respect to one embodiment may be used with other embodiments and that not all embodiments of the invention limited to specific features shown in a particular figure for example the number of frames that should be interlaced to generate the projected image. Variations of embodiments described will occur to persons of the art. Furthermore, the terms “comprise,” “have” and their conjugates, shall mean, when used in the claims, “comprising but not necessarily limited to.” The scope of the invention is limited only by the following claims:

1. A laser projector comprising at least one source for laser beams, a mirror mechanism adapted to reflect laser beams for providing a plurality of projected frames, wherein each of the plurality of projected frames is generated by laser beams scanning an image both in the horizontal direction and in the vertical direction, wherein at least two frames from among said plurality of projected frames are generated by using laser beams each of which having at least one different projecting parameter than the other frame, and wherein said projecting parameter is a member selected from a group consisting of: a frame's starting point for the beam's scanning, a frame's starting scanning time, picture information and horizontal and/or vertical cycle times.

2. A laser projector according to claim 1, further comprising means operative to enable interlacing said at least two frames, generated by using laser beams each of which having at least one different projecting parameter than the other.

3. A laser projector according to claim 1, wherein a projected image is being formed by averaging said plurality of projected frames over a scanning session.

4. A laser projector according to claim 1, further comprising a processing means operative to provide correcting pixel information that has been adjusted to the paths to be travelled by said laser beams in accordance with at least one of the following:
path curvature caused by the use of a biaxial mirror;
path curvature caused due to the positioning of at least one of the mirrors comprised in the mirror mechanism preventing the mirrors' rotational axis from being orthogonal to each other;
path curvature caused by a multiplicity of mirrors; and
deviation in path caused by current position of at least one of the mirrors comprised in the mirror mechanism.

5. A laser projector according to claim 1, further comprising a processing means operative to determine the number of frames required to be interlaced for optimizing the quality of the projected image.

6. A laser projector according to claim 1, further comprising a processing means adapted to execute a real-time pixel-based manipulation to improve the quality of the projected image.

7. A method for projecting an image comprised of a plurality of projected frames by using a laser projector which comprises at least one biaxial mirror or at least one resonant mirror and at least one linear mirror, said method comprising: generating at least two laser beams each adapted to be associated with a different frame from among said plurality of projected frames, wherein each of the at least two laser beams has at least one different projecting parameter than the other, and wherein a projecting parameter is a member selected from a group consisting of: a starting scanning point, starting scanning time, picture information and horizontal and/or vertical cycle times.

8. A method according to claim 7, further comprising a step of pixel manipulation according to paths to be travelled by said at least two laser beams, based upon one or more of the following:
path curvature caused by the use of a biaxial mirror;
path curvature caused due to the positioning of at least one of the mirrors comprised in the mirror mechanism preventing the mirrors' rotational axis from being orthogonal to each other;
path curvature caused by a multiplicity of mirrors; and
deviation in the path caused by current position of at least one of the mirrors comprised in the mirror mechanism.

9. A method according to claim 7, further comprising a step of interlacing said at least two frames and projecting the interlaced frame onto a target.

10. A method according to claim 9, further comprising a step of determining a number of frames required to be interlaced for optimizing the image quality of a projected image.

11. A method according to claim 9, further comprising a step of affecting the image quality by executing a pixel-based manipulation of the interlaced frames to be projected.
